(19) United States
(12) Patent Application Publication
(10) Pub. No.: US 2009/0222790 A1
(43) Pub. Date: Sep. 3, 2009

(54) SYSTEM AND METHOD FOR PROCESSING RESOURCE DESCRIPTION FRAMEWORK DATA

(75) Inventors: Hyun-Wo OH, Daejeon (KR); In Tark Han, Daejeon (KR); Kwang Roh Park, Daejeon (KR); Eun-Sun Cho, Daejeon (KR); Ik-Hyoun Jhin, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/185,345

(22) Filed: Aug. 4, 2008

(30) Foreign Application Priority Data
Feb. 28, 2008 (KR) 10-2008-0018395

(51) Int. Cl. G06F 9/44

(52) U.S. Cl. 717/104

(57) ABSTRACT

The present invention relates to a system and method for processing resource description framework data. The present invention relates to a system and method allowing a general-purpose program to support operation of resource description language (RDF) data models, not operation of RDF ontology using a library. Therefore, it is possible to process RDF data by using an existing high-level programming language. Further, since a developer clearly perceives RDF data models, it is possible to easily operate RDF ontology.

### CROSS-REFERENCE TO RELATED APPLICATION

This application claims priority to and the benefit of Korean Patent Application No. 10-2008-0018395 filed in the Korean Intellectual Property Office on Feb. 28, 2008, the entire contents of which are incorporated herein by reference.

### BACKGROUND OF THE INVENTION

(a) Field of the Invention

The present invention relates to a system and method for processing resource description framework data.

This invention was supported by the IT R&D program of MIC/IITA [2007-S-009-01, Development of Power Platform Technology to Reduce the Power Consumption in Always-On Home Network Systems].

(b) Description of the Related Art

Resource description framework (RDF) models represent their meanings as resources, attributes, and attribute values. Further, the reiteration and ambiguity of tag names that are one of the problems of extensible markup language (XML) can be solved by an idea of ontology using an RDF schema. Usage of the RDF ontology makes it easy to represent the meanings of various components used in documents and the relativity between documents, and makes automatic process between systems easier.

Such RDF ontology is being used in fields of resource discovery, document classification, intelligent software agents, etc.

In order to develop application programs for using RDF ontology that is used in various fields or constructing RDF ontology, it should be possible to easily handle data for resources described in an RDF ontology form by using programming languages. In order to do so, it is required to use additional libraries (e.g., Jena framework, sesame, Redland, semweb, etc.) for handling RDF ontology in general high-level programming languages, such as Java, C++, and C#.

Those various libraries provide an application programming interface (API) that is capable of handling and generating RDF ontology. Further, a query engine for performing a query on RDF ontology and obtaining the results of the query is provided. Therefore, it is possible to easily search data contained in RDF ontology through the libraries, However, if existing high-level programming languages are used to develop application programs, programs becomes long, the development of application programs becomes very complicated, and difficult codes are required for the development. Further, a radical change in grammar (e.g., Java 5 (Java SDK version 1.5)) increases stress of developers who should develop application programs that become increasingly complicated in a short time. Therefore, since existing high-level programming languages require very complicated and standardized codes, it is unreasonable to easily handle or construct RDF ontology in high-level programming languages by using additional libraries.

One of the biggest problems is that if libraries are used to handle RDF ontology, it is impossible to represent the structure of RDF ontology on codes. Unlike an RDF data model in which data is simply expressed in a structure of subject, predicate, and object, there are differences between program development methods of high-level programming languages. Therefore, it is difficult for developers to apparently perceive the structure of RDF ontology being handled from program codes being currently developed.

Further, in order to search data in RDF ontology or to use data in RDF ontology through reasoning, additional query processing engines and reasoning units are required. For such a development method, developers should understand the characteristics of each of query processing engine and reasoning unit. Further, there is a restriction that development is performed depending on the query processing engine and reasoning unit.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method having advantages of processing RDF data by using programming languages.

An exemplary embodiment of the present invention provides a method of processing resource description framework data, the method including:

receiving an input source program and a resource description framework operation command and extracting resource description framework data from the input source program; performing a preprocess on the extracted resource description framework data on the basis of the resource description framework operation command and generating a general-purpose programming language; compiling the general-purpose programming language and generating a resource description framework execution target program; and executing the resource description framework execution target program and processing the resource description framework data.

Another embodiment of the present invention provides a system for processing resource description framework data, the method comprising:

a preprocessor extracting resource description framework data from an input source program and converting the resource description framework data into a general-purpose programming language; a compiler compiling the converted general-purpose programming language and generating a resource description framework execution target program; and an executing unit executing the generated resource description framework execution target program and processing the resource description framework data.

According to the present invention, it is possible to process RDF data by using an existing high-level programming language. Further, since a developer clearly perceives RDF data models, it is possible to easily operate RDF ontology.

### BRIEF DESCRIPTION OF THE DRAWINGS

FIG. 1 is a diagram illustrating an example of a framework that is an RDF data processing unit according to an exemplary embodiment of the present invention.

FIG. 2 is a flowchart illustrating a process in which a developer processes RDF data using the framework according to an exemplary embodiment of the present invention.

FIG. 3 is a diagram illustrating an example of an RDF data processing method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components, and combinations thereof.

Hereinafter, a method of processing RDF data according to an exemplary embodiment of the present invention will be described in detail with reference to the accompanying drawings.

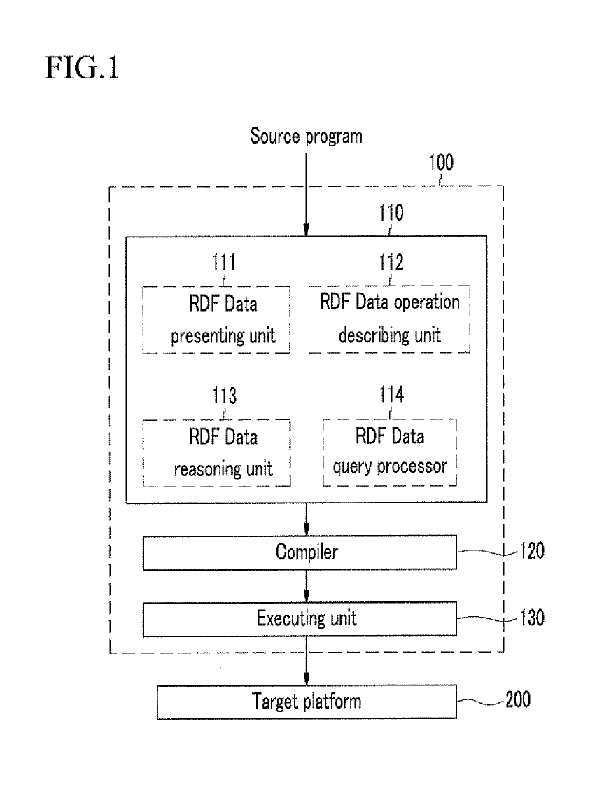

FIG. 1 is a diagram illustrating an example of a framework that is an RDF data processing unit according to an exemplary embodiment of the present invention.

A framework 100 according to an exemplary embodiment of the present invention means a unit for generating an RDF data processing program and executing the generated program. Further, the framework 100 that is described in an exemplary embodiment of the invention is considered to be a data processing system, but is not limited thereto. Since grammar added for an RDF data process is in a programming language, a developer does not need to access a special API for RDF management during program development.

In other words, the framework 100 according to the exemplary embodiment of the present invention expands grammar of a general-purpose programming language in order to easily process RDF data by using the general-purpose programming language. As shown in FIG. 1 a framework that is capable of processing RDF data is constructed on a target platform 200.

The framework 100 includes a preprocessor 110 for extracting RDF data from data input by a user and converting the RDF data into an RDF execution source program based on a general-purpose programming language, a compiler 120 for compiling the RDF execution source program to generate an RDF execution target program, and an executing unit 130 for processing the RDF execution target program.

Here, the preprocessor 110 includes an RDF data representing unit 111, an RDF data operation describing unit 112, an RDF data reasoning unit 113, and an RDF data query processor 114. Further, the compiler 120 and the executing unit 130 also perform the functions of processing a source program and a target program based on a general-purpose programming language.

In order to expand a general-purpose programming language for an RDF data process, expansion is performed so that the following grammar is provided on the basis of those components of the preprocessor 110,

1. Grammar Clearly Describing RDF Data Model

An RDF data model has a very simple structure consisting of a subject, a predicate, and an object. Therefore, the RDF data representing unit 111 represents the grammar of the general-purpose programming language as a set of data serving as a subject, data serving as an object, and data serving as a predicate representing the relation between the data serving as a subject and the data serving as an object.

2. Grammar Describing Relation Operation Between RDF Data Models

In an RDF, the relation representations among a plurality of RDF data models are identical. Therefore, the RDF data operation describing unit 112 may expand the grammar of the general-purpose programming language to describe an RDF data model serving as a subject, an RDF data model serving as an object of relation addition, and the relativity between the two data models, thereby adding the relation between the RDF data models. Further, the RDF data operation describing unit 112 may expand the grammar of the general-purpose programming language to describe an RDF data model serving as a subject, an RDF data model serving as an object of relation removal, and the relativity between the two data models, thereby removing the relation between the RDF data models.

3. Grammar Supporting RDF Ontology Reasoning

The RDF reasons on RDF ontology by using a kind of path expression specialized for RDF data reasoning, below called an ‘RPath expression’, which provides path traversal facilities of an XPath expression for XML data as well as ontology reasoning facilities. An RPath expression selects an RDF ontology or resource serving as a subject and describes only conditions of values and the relation with respect to many object data models having a relation to the selected RDF ontology or resource in stages.

The RPath expression is processed at each stage. Therefore, the RDF data reasoning unit 113 searches for data having a relation through a described predicate in a stage. When the data satisfies given conditions, the data is selected and a description is made so that the data can be used as a subject in the next stage.

4. Grammar Processing Query of RDF Ontology

The RDF data query processor 114 expands the grammar of the general-purpose programming language, and thereby it is possible to effectively search for or extract data from an enormous amount of RDF ontology and to use the handled RPath expression and a query language. The RPath expression may describe conditions on values of object data models and the relativity with respect to all data models of the RDF ontology in stages, thereby checking whether data satisfying conditions described in the RPath expression exist on the RDF ontology. If data satisfying the conditions exist on the RDF ontology, the data are read out and processed.

If using a query language, it is possible to check whether data satisfying a special condition exist on the RDF ontology and to obtain a description on an RDF data model. Further, it is possible to extract a special portion of the current RDF ontology and to construct a new RDF ontology.

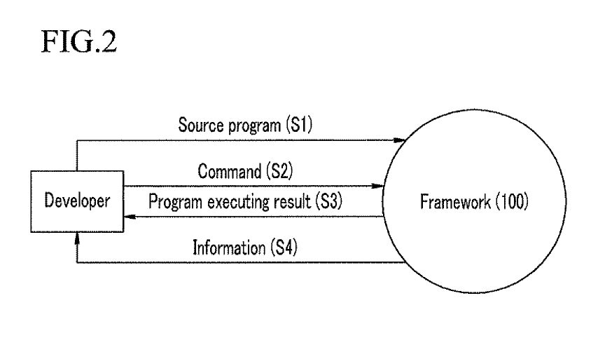

In this way, RDF data can be processed by using the general-purpose programming language, and an RDF data processing method thereof will be described in detail with reference to FIG. 2.

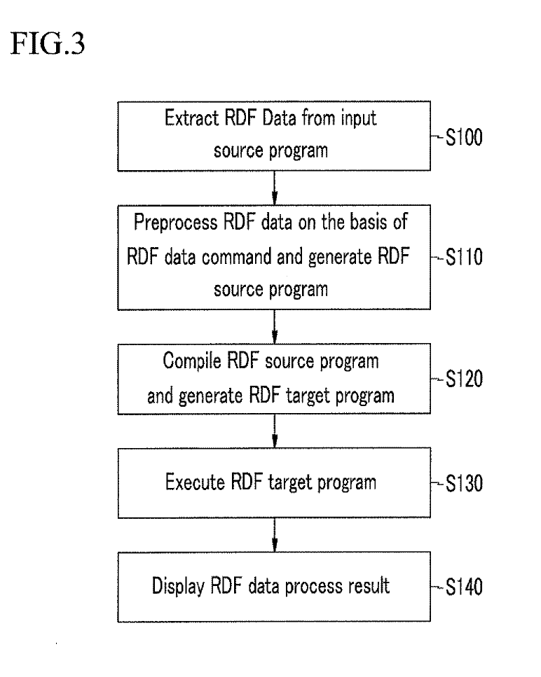

An RDF data processing method using a general-purpose programming language with expanded grammar in which the above-mentioned framework 100 is used as a unit will be described with reference to FIG. 3.

FIG. 2 is a flowchart illustrating a process in which a developer processes RDF data using the framework 100 according to an exemplary embodiment of the present invention.

As shown in FIG. 2, a process of generating and executing an operation program for processing RDF data is similar to usage of a general-purpose programming language in a developer's position. In other words, the developer provides a source program and a command to the framework (S1 and S2), and the framework 100 uses the input source program and the command to execute the program and provides the execution result to the developer (S3). The framework also provides information based on the program execution result to the developer (S4).

As such, a simple-to-use development method is presented to the developer, whereby it is possible to reduce an amount of development time and to reduce the cost needed in order to maintain the RDF data processing system.

Next, an RDF data processing method according to an exemplary embodiment of the present invention shown in FIG. 3 will be described in more detail. In other words, an exemplary embodiment for processing RDF data provided by the framework 100 will be described with reference to FIG. 3.

FIG. 3 is a diagram illustrating an example of an RDF data processing method according to an exemplary embodiment of the present invention.

As shown in FIG. 3, in order to process RDF data by using a general-purpose programming language, first, the preprocessor 110 receives a source program and an RDF operation command and extracts RDF data from the source program (S100). Here, since the structure of RDF data models has been described in advance, a method of extracting RDF data from the source program determines that data having the data model structure are RDF data and extracts the data.

Next, the preprocessor 110 processes the extracted RDF data on the basis of the RDF operation command, and generates a general-purpose programming language (S110). Here, the general-purpose programming language is referred to as an RDF execution source program. In elaborating a method of processing the RDF data in the preprocessor 110, first, a new RDF data model is generated. Then, a name space variable to use a uniform resource identifier (URI, resource address) and a predicate are generated. Here, the predicate means one resource having only a URI, but is not limited thereto.

Next, in order to process the RDF data according to the RDF operation command, the RDF data representing unit 111 makes a clear description of the RDF data model, and the RDF data operation describing unit 112 describes the relativity operation between RDF data models. Here, the clear description of the RDF data model represents the relativity between the subject and a literal after a resource regarding the subject is first generated. Here, the literal means actual data of the subject.

After describing the relativity operation between the RDF data models, the RDF data reasoning unit 113 reasons on the RPath expression, and obtains information from the data models. In order to obtain the information, a second resource having a relation to a first resource through a predicate is searched for, a third resource having a relation to the second resource through a predicate is searched for, and they are returned to a first variable.

Then, a definition is specified so that only resources satisfying predetermined criteria are found from among a plurality of resources having a relation to the first resource through a predicate and they are returned to a second variable. In this case, the first variable, the second variable, the first resource, and the second resource have already been defined at the same time as when the predicate was generated. The resource return or other variable or resource definition methods are known, and thus a detailed description thereof will be omitted in the exemplary embodiment of the present invention.

If a description of a relativity operation is completed, the RDF data query processor 114 searches the information by using the RDF query language and gives a definition to construct or describe a new model.

The compiler 120 compiles the RDF execution source program converted in the preprocessor 110 and generates the RDF execution target program (S120). The RDF execution target program generated by the compiler 120 is executed in the executing unit 130 (S130), the RDF data process result is displayed (S140), and corresponding information is provided to a user.

When an expanded general-purpose programming language is used to process RDF data, it is unnecessary to add RDF data elements in every case. Further, since a complex library is not disclosed to a user, it is possible to prevent confusion caused by calling the library and to reduce coding time for processing RDF data.

The above-mentioned exemplary embodiments of the present invention is not implemented by only a method and system, but can be implemented by a program implementing functions corresponding to the components of the exemplary embodiments of the present invention or a recoding medium with the program recoded thereon. Those implementations can be easily implemented by those skilled in the art from the descriptions of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of processing resource description framework data, the method comprising:
receiving an input source program and a resource description framework operation command and extracting resource description framework data from the input source program;
performing a preprocess on the extracted resource description framework data on the basis of the resource description framework operation command and generating a general-purpose programming language;
compiling the general-purpose programming language and generating a resource description framework execution target program; and
executing the resource description framework execution target program and processing the resource description framework data.

2. The method of claim 1, wherein
the generating of the general-purpose programming language comprises:
describing resource description framework data models;
describing the relativity operation between a first resource description framework data model and a second resource description framework data model;
reasoning the resource description framework data models on data information by using a path expression; and
searching for information by using a resource description framework query language, and constructing a new resource description framework data model.

3. The method of claim 1, wherein
the resource description framework data are represented in the structure of a resource description framework data model, including first data serving as a subject, second data serving as a predicate, and third data representing the relation between the first data and the second data.

4. The method of claim 3, further comprising,
generating the resource description framework data models;
generating a name space variable; and
generating the second data which is a resource having only a resource is address.

5. The method of claim 3, wherein
the describing of the resource description framework data models comprises:
generating a resource with respect to the first data; and
checking the relativity between the first data and the second data.

6. The method of claim 3, wherein
the reasoning comprises:
searching for first resources having a relation to the first data and the second data;
searching for second resources having a relation to the searched first resources and the second data; and
searching for third resources having the first resources and the second resources, searching for only resources satisfying predetermined criteria from among the third resources, and extracting information.

7. A system for processing resource description framework data, the method comprising:
a preprocessor extracting resource description framework data from an input source program and converting the resource description framework data into a general-purpose programming language;
a compiler compiling the converted general-purpose programming is language and generating a resource description framework execution target program; and
an executing unit executing the generated resource description framework execution target program and processing the resource description framework data.

8. The system of claim 7, wherein
the preprocessor comprises:
a resource description framework data representing unit representing the input data in the structure of resource description framework data models, the structure including first data, second data, and third data representing the relation between the first data and the second data;
a resource description framework data operation describing unit describing the relativity between a first resource description framework data model and a second resource description framework data model;
a resource description framework data reasoning unit searching for the first data and the second data through the third data and reasoning on ontology of the resource description framework data; and
a resource description framework data query processor processing a query language for searching for, extracting, and operating the resource description framework data on the ontology of the resource description framework data.

9. The system of claim 8, wherein
the ontology of the resource description framework data is reasoned by using a path expression.
